(19) United States
(12) Patent Application Publication
(10) Pub. No.: US 2011/0135796 A1
(43) Pub. Date: Jun. 9, 2011

(54) High solids adsorbent formulation and spry drying

(76) Inventor: Yun-Feng Chang, Houston, TX (US)

(21) Appl. No.: 12/592,800

(22) Filed: Dec. 3, 2009

(51) Int. Cl. A23K 3/00; B01J 21/16

(52) U.S. Cl. 426/323; 502/80

(57) ABSTRACT

An adsorbent composition prepared based on high solids formulation containing a clay, a binder precursor, optionally an adsorbent additive, a slurring agent and a process for preparing a shaped microspherical adsorbent product to be used in animal feed for reducing feed contamination and preventing bacteria growth and feed spoilage.

### FIELD OF THE INVENTION

The present invention relates to a composition of adsorbent and a process for forming an adsorbent for mitigating toxins in contaminated animal feed or food and for inhibiting growth or formation of bacteria and/or microorganisms in animal feed or food.

### BACKGROUND OF THE INVENTION

Adsorbents find wide range of applications in households, offices, and industries covering from restaurants, hotels, automotive, food processing, fruit transportation and preservation, detergent, desalination, air separation, and petrochemical processes. Adsorbing functionality is essential for all adsorbents, however, it is far from being the only determining factor. In many applications, their other properties, for example, mechanical strength, their form or size and shape, their density, and last but not least their kinetic behavior in terms of adsorption, desorption, and regeneratability.

Adsorbents consist of at least one active component, and additives, and often than not a binder to make them into a shape product. Active components include but limited to natural occurring zeolites, clays, synthetic zeolites, synthetic or modified lays and molecular sieves, charcoals, chars, carbon blacks, high surface area metal oxides, for example, alumina, silica, amorphous alumina-silica, carbon molecular sieves, metal-organic frameworks (MOFS), layered materials, for example, anionic clay, hydrotalcite, and pillared clays.

One type of adsorbent is particular interest as it is used in animal feed to reduce toxin formed due to molds formation during storage or during service asa result of animal food spoilage. This problem is particularly serious in hot and humid regions of the world.

Animal feed is a composite of many ingredients, including added nutrients. When exposed to high humidity or water in hot whether conditions, animal feeds deteriorate or spoil quickly leading to formation of molds. The development of molds leads to production of toxin in the spoiled or contaminated animal feed. Despite all the precautions, limited service portion, improved hygiene conditions of the animal ground, air circulation or ventilation, molds formation cannot be eliminated.

Toxins produced due to molds formation have big consequences in animal health and animal productivity, for instance, reduction in body weight of farm chickens, farm pigs, or reduced milk production in goats and cows. In more severe cases, animal consumed contaminated feed can develop abnormality in organs and even more severe cases cause death. Therefore, there is a strong demand to have adsorbents whose addition to the animal feed can (1) reduce or prevent molds formation, (2) selectively adsorb and remove toxins preventing them from causing harm to animals.

### DESCRIPTION OF THE INVENTION AND EMBODIMENTS

The present invention provides a composition and method of preparing an adsorbent that has high capacity to reduce toxin in animal feed and to inhibit developing or growth of bacteria or microorganisms.

“Adsorbent” refers to materials that have the ability to reduce targeted components through the action of adsorption and/or chemical reaction or ion exchange.

“Form of adsorbent”, to maximize the effect of adsorbents, typically they have to have high surface area and high pore volume to provide locality or sites to remove targeted components that are undesirable. They need to be in the form that can easily be administrated into the materials that contained the targeted components. Usually, they are required to be in the form of granules, pellets, and fine powders.

“Size of adsorbent”, to facilitate mixing and admixing, adsorbent particles need to be in the size range that is similar or close to that of to be treated targets. They are usually from 10 microns to less than 10 mm.

“Adsorption capacity” refers to the amount of target components to be removed and retained on the adsorbent that reaches to its full potential or near its full potential. Usually, it is in milligram of target component per gram of adsorbent.

“Active adsorbent component” refers to the materials that are most active to carry out removal of the targeted components. They are typically selected from the group consisting of clays, both natural and synthetic or modified natural or synthetic clays, natural or synthetic zeolites or aluminoslicates, activated carbons or carbon molecular sieves, charcoals, biochars, porous materials derived from remains of sea creatures, or residues or byproducts of chemical manufacturing processes, for example, ashes from coal combustion or coal gasification, ashes or residues from ores processing.

“Targeted components” refer to the undesirable components to be selectively removed from the targets. They can be toxins present in animal feed, for example, mycotoxins, aflatoxins, agricultural pesticides, allergens, heavy metals, noxious odorants, or other contaminants, or food poisons.

Mycotoxins are the toxic metabolites resulting from fungal infestation and growth on cereal grains and can result from during growth, harvest, transportation or storage of the grains.

Mycotoxin contamination of cereal grains is a relatively common problem. The exact type or extent of the problem is a function of mold types, growing conditions during the crop season and storage practices. Aflatoxins are a mycotoxin of particular concern since the aflatoxin B1 is one of the most potent known hepatocarcinogens. Aflatoxin ingestion is invariably accompanied by a reduction in growth rate of pigs and other animals. Other mycotoxins of concern are fumonisin, vomitoxin, ochratoxin, and seraralenone. Alkaloids of ergot family, such as ergotamine and ergovalene, are also of major concern.

While the acute symptoms of mycotoxins, e.g., aflatoxicosis, in swine are relatively easy to identify and the economical losses evident, the chronic symptoms of slightly diminished performance and immunosuppressive effects probably constitute a much greater economic loss in pork production than for other animals, e.g., beef. Traditional methods of dealing with grains known to be contaminated with mycotoxins are (1) blending with fresh grain to reduce contamination level, (2) screening or other means of physical separation to remove highly contaminated fines, and (3) ammoniation or heating to detoxify the grains. These methods are not effective against ergots.

US patent to Beggs, U.S. Pat. No. 5,149,549, discloses the use of natural bentonite clays, sodium or calcium form, for use as a feed supplement to prevent the absorption of toxins into an animal's bloodstream. US patent to Turk et al, U.S. Pat. No. 5,639,492, discloses an acid-activated montmorillonite clay to treat mycotoxin-contaminated or ergot-contaminated animal feed. US patent to Howes, U.S. Pat. No. 6,045,834, discloses the use of a modified yeast cell wall extract and a mineral clay to contaminated animal feed to inactivate mycotoxins present in the feeds. US patent application to Carpenter et al, US 2009/0117206 A1, discloses a preservative and additive for food and feed using acidified clays and minerals as food or feed additive to kill, or to inhibit the growth of, harmful microorganisms and to inactivate mycotoxins, such as aflatoxins, present as contaminants in human foods and animal feeds, more specifically using a clay of hydrated sodium calcium aluminosilicate with relatively uniform particle size distribution. In all these previous inventions, an acid treatment is essential to achieve the desired effect of decontamination or inactivation of mycotoxins.

The present invention is based on the surprising discovery that bentonite clay in combination with a binder without the need for an acid treatment or activation process fed to animals that are fed a mycotoxin-contaminated animal feed, will unexpectedly provide for almost unhindered weight gain, approximately the same as would occur if the feed were not contaminated.

“Apparent bulk density” refers to the density determined by pouring a given amount of adsorbent (record weight of the adsorbent added) into a measuring device, for example, a 25 cc graduated cylinder having the dimensions of 18 mm inside diameter and 90 mm height at the 25 cc mark with an accuracy to 0.1 cc. Ideally, at least 12 cc of adsorbent volume is required. Once the sample is poured in the cylinder it was tapped on the bottom again a solid lab bench surface for a total of 60 times in 20-25 seconds. Level the top layer of the adsorbent for accurate reading of the volume and record the adsorbent volume after tapping. For example, for 14.268 grams of adsorbent, if it takes 18.5 cc volume after tapping, its apparent bulk density (ABD) is: 14.268/18.5=0.771 g/cc.

“Adsorbent particle” refers to adsorbent of a given particle size and shape applied to a given treatment scenario. For most applications, the average particle size is in the range of 10 microns to 400 microns, most often in the range of 20 microns to 380 microns, for ease of handling and fluid dynamics consideration and in the form of microspheres.

“Particle size distribution (PSD)” describes the relative proportion of individual particle size present in a mix of particle sizes. For ease of handling and for mixing purpose, a certain particle size distribution (PSD) is desired. This is typically defined by a set of particle sizes, for instance, d₁₀, d₅₀, and d₉₀. d₁₀, is the size 10% of the total particle volume is at or below this size. Likewise, d₅₀ is the size 50% of the total particle volume is at or below this size. d₁₀ measures how small the small particles or “fines”. d₅₀ measures the average particle size. d₉₀ measures size of the oversize particles.

Particle size or particle size distribution (PSD) are obtained by well known techniques like (1) sedigraph, for example, Micromeritics SediGraph 5000E, SediGraph 5100 based on particle sedimentation measured by x-ray, it measures particles in the range of 0.5-250 microns; (2) laser scattering, which measures light scattering by particles, particularly small particles, for example, Horiba LA910, Microtrac S3500, Microtrac UPA, Microtrac FRA, measuring particles in the range of 10 nm to 3000 microns; (3) acoustic and electro-acoustic techniques, for example, Matec ESA 9800, Matec AZR-Plus, and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; Dispersion Analyzer LUMiSizer® for particle size from 10 nm to 2000 microns; (5) electroresistance counting method, an example of this type is the Coulter counter, which measures the momentary changes in the conductivity of a liquid passing through an orifice that takes place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 3 nm to 10 microns; (7) electron microscopic imaging, scanning electron microscopy (SEM) and transmission electron microscopy (TEM) can determine both particle size and morphology. Under ideal conditions, particles as small as 1-2 nm to as big as 1 mm can be measured; (8) optical microscopy, it can measure particle size from 1 micron to 10 mm. For typical adsorbent formulation samples, particle sizes to be analyzed range from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, pp. 1-24, 2000. More generic treaty of fine particle characterization can be found in monograph “Analytical Methods in Fine Particle Technology”, by P. A. Webb and C. Orr, Micromeritics Instrument Corp., Norcross, Ga., pp. 17-28, 1997. More comprehensive dealing of particle characterization and preparation can reference the book by J-E. Otterstedt and D. A. Brandreth, “Small Particles Technology”, Plenum Press, New York, p. 8, 1998; and book by A. M. Spasic and J-P. Hsu, “Finely Dispersed Particles: Micro-, Nano-, and Atto-Engineering”, Taylor & Francis, Roca Raton, pp. 329-340, 2006.

“Adsorbent formulation and shaping” refers to a mixture containing various components to be used to make a finish adsorbent product with defined particle size, shape and other physical attributes, including for example, density or bulk density, mechanical strength, etc. Adsorbent formulation can be a slurry, a paste, or dough like semisolid depending on solids content of the mixture. Known techniques used for making shaped adsorbent products include spray drying, extrusion, oil-drop spherical particle formation, pelletization, and granulation.

“Spray drying” refers to a process where an adsorbent formulation in the form of slurry is atomized and dried in a unit called spry dryer. Atomization is achieved using (1) a pressure nozzle, (2) two-fluid nozzle, or (3) a vane wheel atomization. The droplets formed have a very high surface area. Their encounter with heating medium, for example hot air or other hot gas or gas mixture can lead to fast evaporation or drying, generating spherical adsorbent particles. Droplets size varies with solids content of the slurry, particle size of the slurry, size of the atomizer orifice, pressure used for atomization in the case of pressure nozzle or gas flow for two-fluid atomizer, or wheel speed in the case of wheel atomizer. They vary between 20 microns to 300 microns. Consequently, the spherical particles due to drying of the corresponding droplets results in formation of 10 to 150 microns spherical or near spherical adsorbent particles. Spray drying temperature is varied between 100° C. and 550° C. For a given gas flow rate, the higher the drying gas temperature, the greater the drying capacity.

“Binder” is referred to a component added to the adsorbent formulation that its presence has led to major improvement in adsorbent ability to resist to physical breakdown. Depending on binder type, binder's function or effect may only be realized once it has gone through a physical and chemical transformation. For example, an alumina sol is converted into a gamma alumina when it is calcined at temperatures higher than 400° C. Binders are essential to provide mechanical strength of the finish adsorbent particles. Widely accepted binders include colloidal alumina, colloidal silica, and other colloidal sols or precursors.

“Additive” is referred to the material added to adsorbent formulation that its introduction is not for adsorption capacity enhancement nor binding enhancement, but rather, to increase particle density through particle compaction, to improve thermal stability, to reduce slurry viscosity, and adjustment of slurry pH. Known additives used in adsorbent formulation include kaolin clay and other clays or metal oxides. However, some additives may also provide some level of adsorption activity.

“Slurry or suspension” is referred to a mixture of adsorbent components and a dispersing agent, for example, water, and a stabilizing agent or other additives to form a suspension or slurry. To achieve slurry uniformity, mixing or milling devices are used.

“Mixer or mill” refers to equipment or devices used to achieve homogenization of the adsorbent components in the slurry. This includes low shear mixers, blade mixers, saw blade mixers, high shear mixers, for example, Silverson high shear mixer, medium mills, for example Eiger mills, Netzsch mills. In addition to homogenization, particle size reduction is also accomplished. Mixing or milling can be achieved in either a batch mode or continuous circulation mode or combinations of both.

Known milling techniques include but not limited to ball milling, roller milling, sonication, high-shear milling, and medium milling.

In one embodiment, milling is achieved by using a high-shear mixer or mill or a medium mill or mixer or combination of thereof.

It is preferred that after milling particle size d₅₀ or average particle size is reduced by at least 5% from, for example, 20 microns to 19 microns. It is even more preferred that after milling, d₅₀ is reduced by at least 10% from, for example, 20 microns to 18 microns. It is most preferred that after milling d₅₀ is reduced by at least 15% from, for example, 20 microns to 17 microns.

It is recognized that to maximize milling throughput and efficiency a high solids content slurry is desired. However, it is also recognized that slurries having high solids content often encounter high viscosity making them difficult to homogenize, difficult to transport and even more difficult to be milled. Therefore, it is highly desired to have a process that is capable of handling high solids content slurries.

In one embodiment, transportation means that can handle high solids materials, for example, a positive displacement pump is used to carry out slurry transportation from the mixing tank to the mill, for example, Moyno 1000 pump from Moyno Inc., Springfield, Ohio.

In another embodiment, a modifier is added to the slurry so that slurry viscosity can be significantly reduced. It is preferred that the surface modifier added can lead to reduction in slurry viscosity by at least 5%, that is from for example 20,000 cps to 19,000 cps, more preferably at least 10%, that is from for example 20,000 cps to 18,000 cps, and most preferably by at least 15%, that is from for example 20,000 cps to 17,000 cps.

In yet another embodiment, the modifier is an ionic additive or water soluble polymer or dispersing regent selected from inorganic acids, low molecular weight organic acids, polyacids, cationic and anionic water soluble polymers.

In another embodiment, the amount of stabilizing agent added is at least 30 parts per million by weight (wt ppm). It is more preferred that the amount is at least 45 ppm. It is most preferred that the amount is at least 50 ppm.

“Solids content” of the slurry or suspension is defined as the amount of solids particles or residue left after a treatment at elevated temperatures to drive off water, or any other volatiles, or combustion to burn off organics. For example, treatment of adsorbent slurry sample at 550° C. for 2 hours in air resulted in a residue whose mass is 45% of the original mass, that is the solids content of this sediment sample is 45 wt %. The solids content is collection of active adsorbent component, binder, matrix and other introduced materials derived products after the calcination treatment.

“Loss on ignition (LOI)” is used to determine the amount of weight loss of a material after a treatment, often time, referring to calcination, at 550° C. for two hrs. It usually used to indicate the amount of moisture retained by a material or serves as a measurement of organic or volatile organic present in the material. If a material having a starting weight of 100 grams, after calcination at 550° C. for 2 hrs, its weight becomes 94.5 grams, then its LOI is: [(100 grams−94.5 grams)/100 grams*100]=5.5 wt. %.

“Dispersant or dispersion aid or surface modifier” refers to a class of components or chemicals that their addition in a small amount to a slurry or suspension can result in a significant improvement in dispersion, that is (1) increased rate of breakdown of large lumps, (2) better wetting of dry particles or powder introduced into the slurry or suspension; (3) reduced viscosity. These changes or improvements are closely related to alteration in surface properties, surface charge, charge density or zeta potential. Detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004. They include, ionics, cationic, anionic, and zwitterionic; and non-ionics.

Zwitterionics contain both an anionic and a cationic charge under normal conditions, for example molecules containing a quaternary ammonium as the cationic group and a carboxylic group as the anionic group. For ionic surface modifiers the higher the charge density the more effective in surface modification. For example, according to Patton (T. C. Patton, Paint Flow and Pigment Dispersion-A Rheological Approach to Coating and Ink Technology, 2nd Edition, John Wiley & Sons, New York, p. 270, 1979), efficacy of cations or anions in surface modification increased from monovalent to divalent to trivalent in a ration of 1:64:729.

Non-ionic surface modifiers are polyelthylene oxide, polyacrylamide (PAM), partially hydrolyzed polyacrylamide (HPAM), and dextran.

Anionic surface modifiers include, carboxylate, sulfate, sulfonate and phasphate are the polar groups found in anionic polymers. Examples of water soluble anionic polymer are: dextran sulfates, high molecular weight ligninsulfonates prepared by a condensation reaction of formaldehyde with ligninsulfonates, and polyacrylamide. Commercially available anionic water soluble polymers include polyacrylamide, CYANAMER series from Cytec Industries Inc., West Paterson, N.J., like, A-370M/2370, P-35/P-70, P-80, P-94, F-100L & A-15; CYANAFLOC 310L, CYANAFLOC 165S.

Cationic surface modifiers: The vast majority of cationic polymers are based on the nitrogen atom carrying the cationic charge. Both amine and quaternary ammonium-based products are common. The amines only function as an effective surface modifier in the protonated state; therefore, they cannot be used at high pH. Quaternary ammonium compounds, on the other hand, are not pH sensitive. Ethoxylated amines possess properties characteristic of both cationic and non-ionics depending on chain length. Examples of water soluble cationic polymers are: polyethyleneimine, polyacrylamide-co-trimethylammonium ethyl methyl acrylate chloride (PTAMC), and poly(N-methyl-4-vinylpyridinium iodide. Commercially available materials include: Cat Floc 8108 Plus, 8102 Plus, 8103 Plus, from Nalco Chemicals, Sugar Land, Tex.; polyamines, Superfloc C500 series from Cytec Industries Inc., West Paterson, N.J., including C-521, C-567, C-572, C-573, C-577, and C-578 of different molecular weight; poly diallyl, dimethyl, ammonium chloride (poly DADMAC) C-500 series, C-587, C-591, C-592, and C-595 of varying molecular weight and charge density, and low molecular weight and high charge density C-501.

Zwitterionics: Common types of zwitterionic compounds include N-alkyl derivatives of simple amino acids, such as glycine (NH₂CH₂COOH), amino propionic acid (NH₂CH₂CH₂COOH) or polymers containing such structure segments or functional group.

“Methylene blue adsorption capacity” refers to the uptake of methylene blue by a clay, more specifically, expandable clays, for instance, bentonite or montmorillonite. This uptake is related to the amount of exchangeable cationic sites in a material. It calls for weighing 0.20 grams of dried clay at 110° C. for 2 hrs, and mixes with 50 cc of distilled in a 250 cc beaker. To this mixture, 20 cc of 1% sodium polyphosphate (Na₄P₂O₇) is added. This mixture is heated on a hot plate to a gentle boil for 5 minutes before cooling down to room temperature for titration. Titration is carried on a magnetic stirrer by introducing a methylene blue solution containing 2.35 grams in 1000 cc of distilled water using a titration burette (50 cc). When the amount of methylene blue solution used reaches 28 cc, dip a laboratory glass rode into the titrated clay suspension and let a drop of the liquid from the titration mixture to put onto a piece of medium coarse filtration paper to see if a diffuse bluish circle is formed. If no bluish circle, continue titration. This process of titration and checking for diffuse bluish circle is continued till a distinguishable 1 mm thick bluish circle is formed. The amount of the methylene blue solution consumed is methylene blue adsorption capacity in g of methylene blue/100 g of clay. For a good quality bentonite, a value of 35 g per 100 g or higher is required.

“Montmorillonite content” refers to the ability of clay material to form a stable aqueous suspension in the presence of an electrolyte. The volume of the suspended phase under defined conditions is a direct measurement of the amount of montmorillonite present in the clay sample. The greater this volume is the higher its montmorillonite content is. The standard procedure for making this measurement is carried by forming a slurry of the clay in an ammonium chloride solution. It calls for adding 3.0 grams of bentonite (dried at 110° C. for 2 hrs) into 20-30 cc of distilled water inside a 100 cc graduate cylinder, then add to 95 cc mark by adding distilled water. Shake the mixture well and add 5 cc of 1.0 M ammonium chloride water solution to make the total volume to 100 cc. Again, shake the 100 cc mixture and let it sit for 24 hrs before taking reading the volume of the suspension. Typically, a clay with rather high montmorillonite content has a value of 15 cc or higher.

To further illustrate the present invention, a number of examples are provided below.

### EXAMPLES

### Example-1

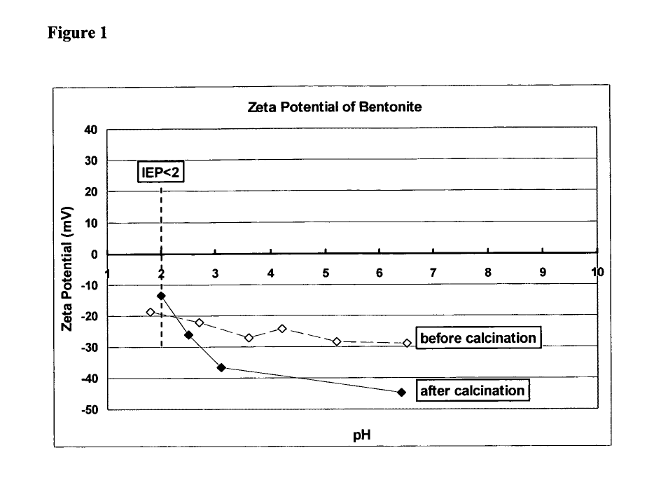

A bentonite was obtained from Jianping Clay Company, Liaoning, China. This clay is produced and manufactured in the region of Jianping, bordered between Hebei and Liaoning provinces. It is a partially modified bentonite using a calcium source. This bentonite has a methylene blue adsorption capacity of 35 g/100 g and a montmorillonite content of 18 cc. Both two parameters suggest it is a good quality bentonite. It has a solids content of 85.25%. A slurry was prepared by suspending the clay to distilled water under high shear mixing using a Silverson homogenizer L4RT from Silverson Machines Inc., East Longmeadow, Mass., at 5000 RPP to 7000 RPM. This slurry was then used for zeta potential measurement using a Brookhaven ZetaPals instrument from Brookhaven Instruments Corporation, Holtsville, N.Y. The bentonite clay slurry was diluted in 0.001M potassium chloride solution before being measured using the ZetaPals instrument. Solids content of the sample is controlled at 0.03 mg per milliliter potassium chloride solution. pH adjustment was made by using potassium hydroxide and nitric acid. The results for an as-is bentonite and its calcined product are given in FIG. 1. Both samples have either no or very low isoelectric points (IEP).

### Example-2

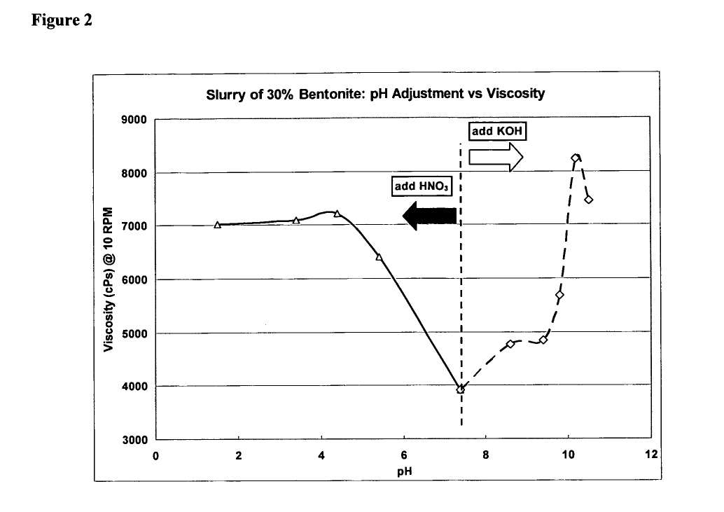

A slurry was prepared using a similar bentonite used in Example 1 but was obtained from Hichord Biotechnology Limited, Beijing, China. This bentonite has a methylene blue adsorption capacity of 48 g/100 g and a montmorillonite content of 8 cc. Both two parameters suggest it is a good quality bentonite. It has a solids content of 87.8%. A slurry was prepared by suspending the clay to distilled water under high shear mixing using a Silverson homogenizer L4RT from Silverson Machines Inc., East Longmeadow, Mass., at 5000 RPP to 7000 RPM. At 30% solids content this slurry gave a rather high viscosity. At 30% solids content, this slurry had a viscosity measured at 10 RPM using a Brookfield Viscometer II+ of 3920 cPs. FIG. 2 shows the impact of pH adjustment on slurry viscosity. A high concentration nitric acid and 10% potassium hydroxide solution were used to lower and raise pH respectively and to minimize any significant change in slurry solids content during pH adjustment. Therefore, viscosity changes is solely due to variation of pH as slurry solids content remained virtually constant. From FIG. 2, it appears that slurry exhibited a minimal viscosity at pH near 7.4. Lowering pH resulted in drastic increase in slurry viscosity, reaching a maximum at pH of 4. Raising pH above neutral pH led to increase in slurry viscosity. However, viscosity increase only took a big upward turn when pH was increased to above 9.5.

### Example-3

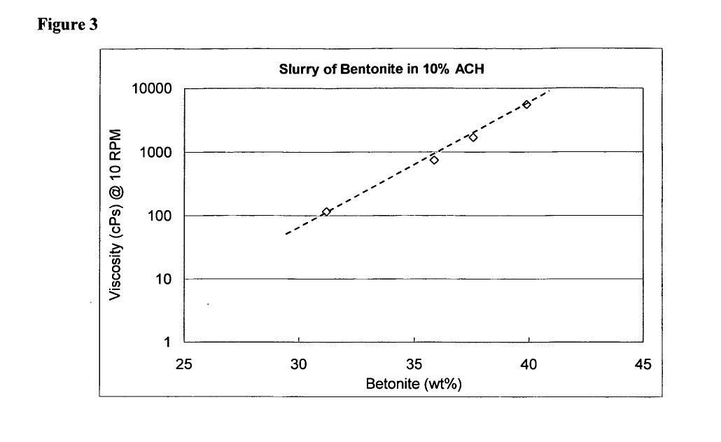

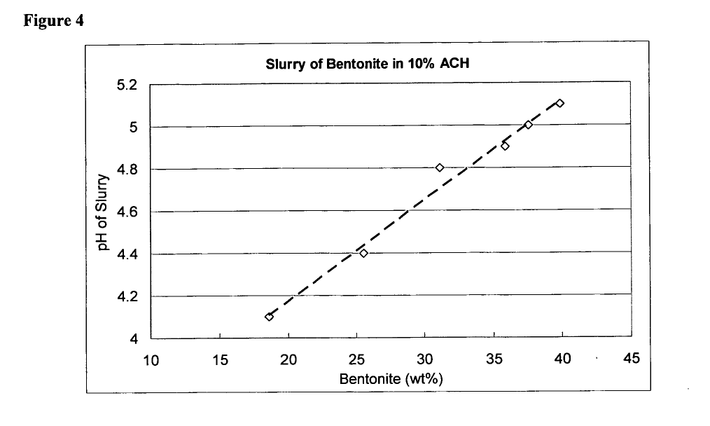

Slurries were prepared using the same bentonite used in Example 2 obtained from Hichord Biotechnology Limited, Beijing, China. This bentonite has a methylene blue adsorption capacity of 48 g/100 g and a montmorillonite content of 8 cc. Both two parameters suggest it is a good quality bentonite. It has a solids content of 12.2%. A slurry was prepared by adding the clay to an aqueous solution of aluminum chlorohydrate (ACH) from Shanghai Dome Chemicals Ltd., Shanghai, China that had a solids content of 10%. Mixing was achieved during clay addition using a Silverson homogenizer L4RT from Silverson Machines Inc., East Longmeadow, Mass., at 5000 RPP to 7000 RPM. In contrast to that of Example 2, this slurry had a much lower viscosity, at solids content of 31.17%, viscosity was only 114 cPs. This is the direct effect of introducing aluminum chlorohydrate (ACH). In the presence of ACH, one can achieve solids content of clay of 40%, which is impossible to achieve in the absence of ACH. Viscosity of the slurry increased as more clay was added. FIG. 3 shows the impact of clay addition (solids content) on slurry viscosity. As more clay was added to the ACH solution, pH of the resultant slurry increased steadily as show in FIG. 4.

### Example-4

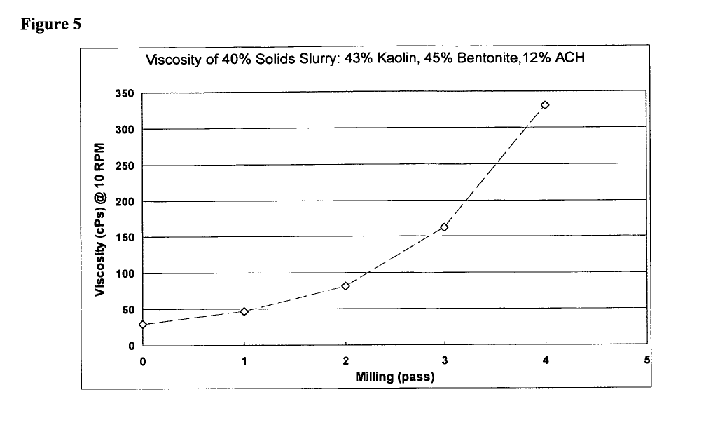

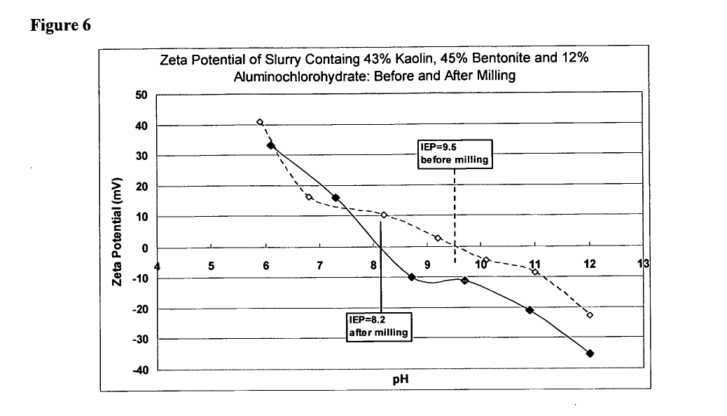

Added 1352 grams of aluminum chlorhydrate sol (LOI: 75.15%) from Domen Chemical Company, Shanghai, China to 2994 grams of distilled water while under mixing using a mixer at 600 RPM. This sol now had a pH of 4.4 measured at 21° C. To this sol, 1219 grams of kaolin clay (LOI: 1.2%) from Jufeng Clay Company, Shanxi, China was added while under mixing. This mixture had a pH of 4.2 measured at 21° C. An amount of 1435 grams of bentonite (LOI: 22.2%) from Chifeng Clay Company, Hebei, China was added to the mixture containing aluminum chlorohydrate and kaolin clay while under high shear mixing using a Silverson L4RT high shear mixer at 8000 RPM for 3 minutes. Now this slurry had a pH of 4.7 measured at 25° C. This slurry had a solids content of 40%. Its viscosity measured using a Brookfield Viscometer II with a #1 spindle at 10 RPM is 29 cPs measured at 21° C. Milling of this slurry was carried out at agitation speed of 3600 RPM using an Eiger MINI 250 mill from Eiger Machinery Inc., Grayslake, Ill. Zirconia microspheres of 2.0 mm in size from Tosoh Corporation, Tokyo, Japan was used for milling. Milling using Eiger mill had led to steady increase in viscosity as shown in FIG. 5. The increase in viscosity is accompanied by a significant reduction in isoelectric point (IEP) as shown in FIG. 6 from 9.5 to 8.2. An IEP of 9.5 is very close to that of an ACH solution. A significant reduction in IEP suggests that the amount of ACH per surface area of clay sample is substantially reduced, indicating more surface area had become available after milling, a direct evidence that milling had led to exfoliation of the bentonite clay.

The milled slurry after four passes of milling using Eiger mill was used for spray drying. A Niro Utility Spray Dryer from Niro A/S, Copenhagen, Denmark, was used for spray drying. Atomization was achieved using a spinning wheel that can operate at 6,000 RPM to 20,000 RPM. Results from the spray dry and conditions used for spray drying are given in Table 1. The spray dried product had an ABD of 0.87 g/cc after being calcined. Upon examination of the spray dried products, most of the product particles were near perfect mcirospheres.

TABLE 1
Summary of Spray Drying Slurry Containing 40% Solids

| Slurry Property | | Spray Drying Conditions | | | | Spray Dried Product | | |
|---|---|---|---|---|---|---|---|---|
| Slurry Solids | Slurry Viscosity | | Wheel Speed | Tᵢₙₗₑₜ | Tₒᵤₜₗₑₜ | Product | ABD | d₅₀ |
| (wt %) | (cPs) @ 10 RPM | Atomizer | (RPM) | (° C.) | (° C.) | Yield (%) | (g/cc) | (μm) |
| 40 | 9500 | Wheel | 10,000 | 300-302 | 120-124 | 86.3 | 0.87 | 66 |

### Example-5

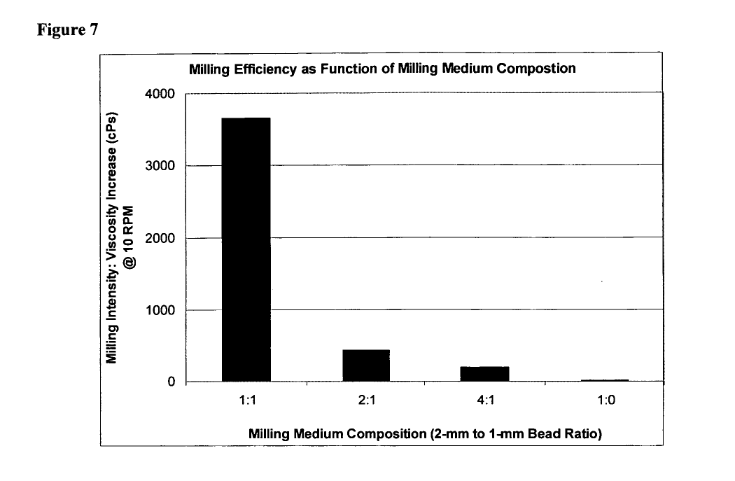

Added 1352 grams of aluminum chlorhydrate sol (LOI: 75.15%) from Domen Chemical Company, Shanghai, China to 2994 grams of distilled water while under mixing using a mixer at 600 RPM. This sol now had a pH of 4.4 measured at 21° C. To this sol, 1219 grams of kaolin clay (LOI: 1.2%) from Jufeng Clay Company, Shanxi, China was added while under mixing. This mixture had a pH of 4.2 measured at 21° C. An amount of 1435 grams of bentonite (LOI: 22.2%) from Chifeng Clay Company, Hebei, China was added to the mixture containing aluminum chlorohydrate and kaolin clay while under high shear mixing using a Silverson L4RT high shear mixer at 8000 RPM for 3 minutes. Now this slurry had a pH of 4.7 measured at 25° C. This slurry had a solids content of 40%. Its viscosity measured using a Brookfield Viscometer II with a #1 spindle at 10 RPM is 29 cPs measured at 21° C. Milling of this slurry was carried out at agitation speed of 3600 RPM using an Eiger MINI 250 mill from Eiger Machinery Inc., Grayslake, Ill. To those skilled in the art, the well established milling practice is through selection of a particular medium size to achieve desired milling. For this reason, a large selection of milling medium sizes has to be available. We found unexpectedly that by using a combination of two sizes, one is at 1 mm and other is at 2 mm, one could achieve a wide variation in milling efficiency. The milling efficiency is measured as the viscosity increase after passing the slurry through the Eiger mill once while operates at the same agitation speed and a constant total amount of milling medium charged into the mill. The higher the viscosity increase the more energy intensity is the milling. The results for milling the 40% solids slurry at different medium composition, that is, the ratio between the 2 mm medium and the 1 mm milling medium are given in FIG. 7. The higher amount of the smaller medium in the total charge the more efficient it is for milling. To one's surprise, by varying milling medium from 2 mm to a 50:50 mix of 2 mm medium and 1 mm medium, the milling efficiency has improved by a factor 20 as measured by viscosity change of the milled product from 18 cPs to 3655 cPs. Table 2 provides rheological property of the milled slurries to further illustrate the impact of milling medium composition and number of milling passes on viscosity.

TABLE 2
Rheological Property of Milled Slurry at Different Milling
Medium Composition

| # of Milling | | | Slurry |
|---|---|---|---|
| Passes | Milling Medium Mass | Spindle Speed | Viscosity |
| @ 2000 RPM | Ratio (2 mm:1 mm) | (RPM) | (cPs) |
| 1 | 2:1 | 10 | 490 |
| 2 | 4:1 | 10 | 3100 |
| 3 | 4:1 | 10 | 9500 |

### Example-6

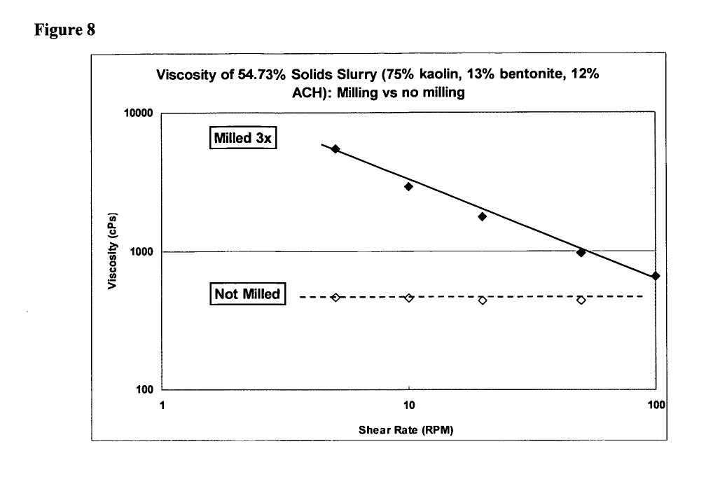

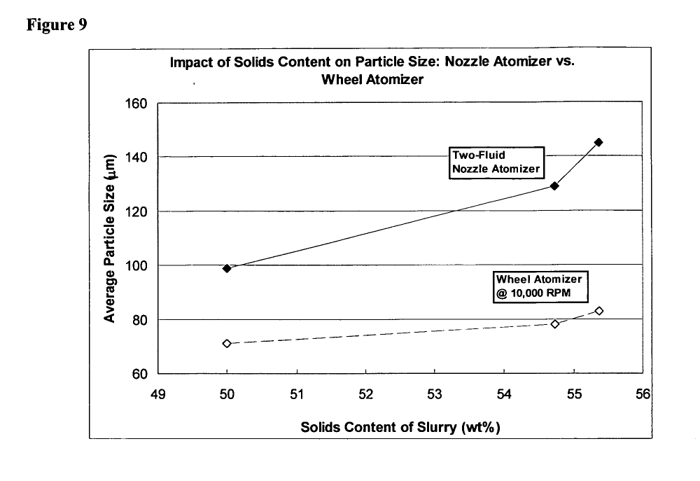

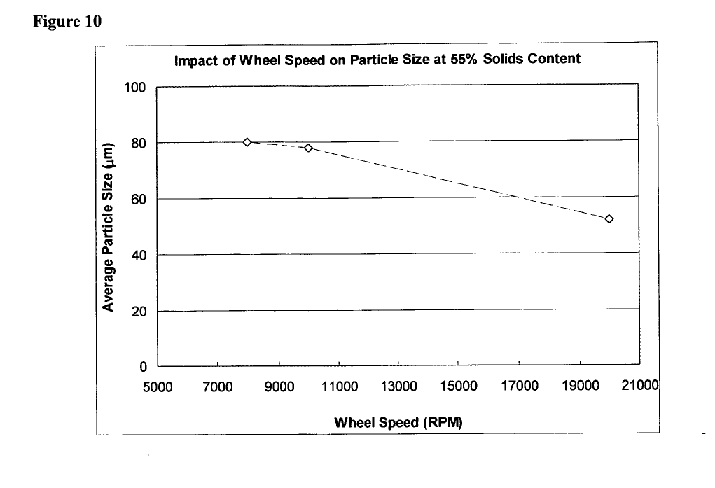

Added 1310 grams of aluminum chlorhydrate sol (LOI: 75.15%) from Domen Chemical Company, Shanghai, China to 1205 grams of distilled water while under mixing using a mixer at 600 RPM. This sol now had a pH of 3.4 measured at 20° C. To this sol, 2082 grams of kaolin clay (LOI: 1.2%) from Jufeng Clay Company, Shanxi, China was added while under mixing. This mixture had a pH of 3.3 measured at 21° C. Amount of 403 grams of bentonite (LOI: 22.2%) from Chifeng Clay Company, Hebei, China was added to the mixture containing aluminum chlorohydrate and kaolin clay while under high shear mixing using a Silverson L4RT high shear mixer at 8000 RPM for 3 minutes. Now this slurry had a pH of 3.7 measured at 21° C. This slurry had a solids content of 54.73%. Its viscosity measured using a Brookfield Viscometer II with a #2 spindle at 10 RPM is 460 cPs measured at 21° C. Milling of this slurry was carried out at agitation speed of 3600 RPM using an Eiger MINI 250 mill from Eiger Machinery Inc., Grayslake, Ill. Zirconia beads of 1 mm from Tosoh Corporation, Tokyo, Japan, was used for milling. A total of 3 passes of milling were carried out. This had led to a high viscosity slurry. The milled product showed a strong shear thinning behavior as shown in FIG. 8. For comparison, the corresponding slurry before milling was also given in FIG. 8. The milled slurry was spray dried using the same set up of spray dryer and operation conditions as used in Example 4. Table 3 summarizes spray dry of the slurry of 54.73% solids content after milled three passes. A distinction of this spray dried product is its density. It is a lot higher than those from previous formulation. This illustrates the importance of high solids content formulation in improving product density. Furthermore, slurries of different solids content were made and spray dried. The results are presented in FIG. 9 and FIG. 10. Product particle size can be varied by varying solids content of the slurry. Furthermore, particle size can be varied by using different atomization technique. We have found the two-fluid nozzle gave much bigger particles than the wheel atomizer as shown in FIG. 9. FIG. 10 provides the degree of particle size control through varying wheel speed. A higher wheel speed results in finer particle size.

TABLE 3
Summary of Spray Drying of Slurry of 54.73% Solids Content

| Slurry Property | | Spray Drying Conditions | | | | Spray Dried Product | | |
|---|---|---|---|---|---|---|---|---|
| Slurry Solids | Slurry Viscosity | | Wheel Speed | Tᵢₙₗₑₜ | Tₒᵤₜₗₑₜ | Product | ABD | d₅₀ |
| (wt %) | (cPs) @ 10 RPM | Atomizer | (RPM) | (° C.) | (° C.) | Yield (%) | (g/cc) | (μm) |
| 54.73 | 2900 | Wheel | 10,000 | 303-305 | 128-134 | 80.3 | 0.95 | 78 |

### Example 7

A slurry of a bentonite from Jianling Clay Company, Jianping, Liaoning, China was obtained by adding 852.9 grams of the bentonite to 3147.1 grams of distilled water under mixing. This slurry was milled using the same Eiger mill used in Example ## and milling medium of 4:1 mass ratio of 2 mm zirconia to 1 mm zirconia beads both from Tosoh Corporation, Tokyo, Japan, the same beads that are used in other examples, Examples 4-6. Milling was carried out at 2000 RPM agitation speed. The results are presented in Table 4. Milling had led to steady increase in slurry viscosity. As viscosity of the slurry increased, milling throughput reduced significantly, from 2203 g/min at 1220 cPs to 1030 g/min at 5320 cPs both measured at 10 RPM using a Brookfield viscometer II Plus with a #5 spindle. It is also noticed that milling resulted in gradual increase in slurry pH from 7.5 of the slurry that is not milled to 7.9 after three passes of milling. Milling also led to appreciable increase in slurry temperature from 9° C. to 11° C. for the first pass, and 9° C. to 12° C. after the second pass, temperature for the third pass is significantly less from 11° C. to 12° C.

TABLE 4
Summary of Milling of 18% Bentonite Clay using Eiger Mill

| # of | | Agitation | Throughput | | | Viscosity |
|---|---|---|---|---|---|---|
| Passes | | Speed | of Milling | T_{before} | T_{after} | (cPs) @ |
| Milled | pH | (RPM) | (g/min) | (° C.) | (° C.) | 10 RPM |
| 0 | 7.5 | NA | NA | 9 | 9 | 136 |
| 1 | 7.7 | 2000 | 2203 | 9 | 11 | 1220 |
| 2 | 7.8 | 2000 | 1600 | 9 | 12 | 2750 |
| 3 | 7.9 | 2000 | 1030 | 11 | 12 | 5320 |

### Example 8

A slurry of 50% solids content containing bentonite clay, kaolin clay, aluminum chlorohydrate was made by (1) mixing 1229 grams of aluminum chlorohydrate (LOI: 75.15%) with 1708 grams of distilled water, giving a mixture having pH of 3.6 measured at 19° C.; (2) to mixture (1) adding 1306 grams of kaolin clay (LOI: 1.2%) under mixing, giving a slurry having pH of 3.4 measured at 19° C.; (3) to mixture (2) adding 1538 grams of bentonite (LOI: 22.2%) under high shear mixing using a Silverson L4RT homogenizer at 8500 RPM for 30 minutes, resulting in a high viscosity slurry having pH of 4.2 measured at 34° C. Due to the extremely high viscosity, it was diluted to low viscosity. The results are summarized in Table 5.

TABLE 5
Summary of Properties of Slurry of 45% Bentonite, 43% Kaolin and 12% ACH

| Solids Content | Treatment of | pH of | Temp | Viscosity (cPs) @ 10 RPM | | | | |
|---|---|---|---|---|---|---|---|---|
| (wt %) | Slurry | Slurry | (° C.) | 5 | 10 | 20 | 50 | 100 |
| 50 | High shear mxing at | 4.2 | 34 | 30200 | 17700 | 11000 | 6100 | 4000 |
| | 8500 RPM for 30 min | | | | | | | |
| 48 | Dilution | 4.3 | 31 | 8240 | 5520 | 3620 | 2160 | 1520 |
| 47 | Dilution | 4.4 | 27 | 3520 | 2680 | 1960 | 1280 | 952 |
| 45 | Dilution | 4.7 | 27 | 816 | 656 | 520 | 396 | 350 |
| 40 | Dilution | 4.8 | 27 | 96 | 76 | 70 | 72 | 89 |
| 35 | Dilution | 4.9 | 26 | 32 | 29 | 28.5 | 34 | 43 |

### Example-9

To avoid high viscosity during milling, a lower solids content has to be selected. Table 6 summarizes results for attempting to maximize solids content and to achieve multiple passes of milling using Eiger mill at agitation speed of 3600 RPM. Even at solids content of 39%, difficulties were still encountered in milling. A solids content of 38% was selected. Three passes of milling were achieved. The final slurry had a viscosity of 7500 cPs measured at 10 RPM using a #5 spindle of Brookfield viscometer II Plus.

TABLE 6
Summary of Milling of Slurries containing 45% Bentonite,
43% Kaolin and 12% ACH at Different Solids Content

| Solids | Treatment of | | pH of | Milling Rate | Tᵢₙₗₑₜ | Tₒᵤₜₗₑₜ | Viscosity (cPs) |
|---|---|---|---|---|---|---|---|
| Content (wt %) | Slurry | Comments | Slurry | (g/min) | (° C.) | (° C.) | @ 10 RPM |
| 35 | EigerMill 1x | Milling fast | 5.2 | 4167 | 19 | 21 | 39 |
| 35 | Eiger Mill 2x | Milling fast | 5.2 | 3767 | 21 | 24 | 81 |
| 35 | Eiger Mill 3x | Milling fast | 5.2 | 3175 | 23 | 25 | 292 |
| 38.8 | Eiger milling | Milling OK | 6 | NA | 25 | 25 | 106 |
| 40 | Eiger milling | Locked up | 6.1 | NA | NA | 27 | 152 |
| | | milling medium | | | | | |
| 39 | Eiger milling | Diluted; milling | 4.7 | NA | NA | 29 | 442 |
| | | Difficulties | | | | | |
| 38 | Eiger milling | Diluted; milling | 4.8 | NA | NA | 30 | 242 |
| | | OK; 1x | | | | | |
| 38 | Eiger milling | Diluted; milling | 4.8 | NA | NA | 31 | 1300 |
| | | OK; 2x | | | | | |
| 38 | Eiger milling | Diluted; milling | 4.8 | NA | NA | 30 | 7500 |
| | | OK; 3x | | | | | |

NA: Not Available

### Example-10

Table 7 illustrates the critical importance of milling using Eiger mill for formulations that all had the same composition, 45% bentonite, 43% kaolin clay and 12% aluminum chlorohydrate and the same exact slurry preparation procedure. Without being milled, the slurry solids content could go up to 48% while maintaining not too high viscosity (see Experiment SL-73A). Due to the high solids content, spray drying of this slurry resulted in coarser product. However, its product had lower comparable ABD as those produced from much lower solids content slurries but milled using energy intensive Eiger mill, Experiment SL-68, SL-70 and SL-71. What is striking is that spray dried products derived from the Eiger milled products all showed much improved mechanical strength than those made from slurries that were not milled. The high mechanical strength of spray dried products is desired to avoid breakdown of the product during transportation or storage and handling. Fines generated from breakdown of large particles not only lead to loss of adsorbent but also possess health threat to those who handle them. Therefore, a mechanically strong product provides the best benefit in terms of adsorption capacity and reducing any potential risk to personnel handling the animal feed additive and animals who are fed with these adsorption additives.

TABLE 7
Impact of Milling on Product Quality:
Density and Mechanical Strength

| Slurry Property | | | | | | |
|---|---|---|---|---|---|---|
| | Solids | | Viscosity | Spray Dried Product | | |
| Exper- | Content | Milling | (cPs) @ | ABD | PSD d₅₀ | Mechanical |
| iment | (wt %) | (passes) | 10 RPM | (g/cc) | (μm) | Strength^{a} |
| SL-68 | 36 | 3 | 1500 | 0.867 | 65 | ++++/2 |
| SL-70 | 34 | 27 | 7100 | 0.905 | 60 | ++++ |
| SL-71 | 30 | 65 | 6150 | 0.922 | 57 | ++++ |
| SL-73A | 48 | 0 | 5240 | 0.88 | 69 | + |
| SL-73B | 46.3 | 0 | 1840 | 0.924 | 70 | ++ |
| SL-73C | 45 | 0 | 664 | 0.907 | 69 | ++/2 |
| SL-73D | 42 | 0 | 144 | 0.891 | 63 | + |

^{a}number of “+” = mechanical strength of ++++ > ++++/2 > +++ > +++/2 > ++ > +

Through the examples provided above, it has demonstrated that one can achieve not only balanced product throughput but also much better product quality through milling. Extended milling has led to products of higher density and better mechanical strength despite not so high solids content.

Without wishing to be bound by any particular theories, we have succeeded in making adsorbent of superior performance quality through formulation.

Energy intensive milling has let to uniform particle size distribution and homogenization of the formulation components. This has been illustrated from surface charge measurement results obtained using a ZetaPals instrument from Brookhaven Instruments, Holtsville, N.Y., USA. Milling results in lower IEP, a direct evidence of redistribution and exfoliation of bentonite clay sheets. This exfoliation leads to exposure of more clay basil planes and making more surface sites available for adsorption and removal of contaminants and toxins present in animal feed.

Without wishing to be bound to any particular theories, we have demonstrated that drastic improvements in mechanical strength and particle density are achieved by controlling milling to provide adsorbents of high adsorption capacity and low fines make based on clays and a binder. Spray drying has been used to make microspherical particles that have better material handling and easy to mix or admix as an additive to animal feed. To those skilled in the art, it can be envisioned that this invention can be applied to preparation of many different adsorbent composition and forms as an adsorbent or as a carrier for nutrients, or drug delivery aid. Also, to those skilled in the art, other components can be incorporated into the formulation, this includes but not limited to high surface area and high pore volume aluminosilicates both synthetic and natural occurred, carbonaceous materials, metal oxides, residual from cells or sea creatures, ashes from plants, or organic materials.

### FIG. 1

Zeta potential measurement results of bentonite: before and after calcination. Calcination was done at 550° C. in air for 2 hrs. This bentonite is negatively charged through the entire pH range investigated, 2 and higher. It either does not have an isoelectric point (IEP) or very low value, <2. Clacination has led to higher zeta potential under same pH conditions.

### FIG. 2

This is demonstration of major viscosity change through pH adjustment. The slurry contains 30% solids of bentonite. Detail description is in Example 2.

### FIG. 3

When aluminum chlorohydrate (ACH) is used, slurry viscosity is greatly reduced, consequently more bentonite clay can be added, a clear demonstration of present invention to achieve high solids content formulation. Detail description of sample preparation refers to Example 3.

### FIG. 4

pH change of slurry containing 10% aluminum chlorohydrate and varying amount of bentonite. Addition of bentonite results in steady increase in pH. Detail description of sample preparation refers to Example 3.

### FIG. 5

Milling of 40% solids content slurry containing 43% kaolin clay, 45% bentonite, and 12% aluminum chlorohydrate using Eiger mill leads to continuous substantial increase in slurry viscosity. Detail description of sample preparation refers to Example 4.

### FIG. 6

Milling has led to dispersion (defoliation) of bentonite clay as indicated by the shifting of IEP from 9.5 before milling to 8.2 after milling. Detail description of sample preparation refers to Example 4.

### FIG. 7

It is a demonstration of impact of milling efficiency (intensity) by varying mass ratio of 2 mm zirconia milling medium to 1 mm zirconia milling medium. Detail description is provided in Example 5.

### FIG. 8

Viscosity behavior of slurry having a solids content of 54.73% containing 75% kaolin clay, 13% bentonite, and 12% aluminum chlorohydrate before and after milling using Eiger mill. The milled slurry shows a strong shear thinning characteristics. Detail description is provided in Example 6.

### FIG. 9

This demonstrates the striking difference in particle size of product obtained using a two-fluid nozzle atomizer versus using a wheel atomizer. It further illustrates the impact of solids content of slurry on particle size of spray dried products. Detail description is provided in Example 6.

### FIG. 10

This demonstrates the impact of wheel speed on particle size of spray dried products on a 55% solids content slurry. A high wheel speed leads to a smaller particle size. Detail description is provided in Example 6.

### REFERENCES

1. L. Beggs, U.S. Pat. No. 5,149,549
2. K. R. Turk, L. Music and G. W. Beall, U.S. Pat. No. 5,639,492
3. R. H. Carpenter, M. C. Kemp, K. C. McKensie, US 2009/0117206 A1
4. A. D. Howes, and K. E. Newman, U.S. Pat. No. 6,045,834
5. R. L. Xu, “Particle Characterization: Light Scattering Method”, Kluwer Academic Publisher, Dordrecht, The Netherlands, pp. 1-24, 2000.
6. P. A. Webb and C. Orr, “Analytical Methods in Fine Particle Technology”, Micromeritics Instrument Corp., Norcross, Ga., pp. 17-28, 1997.
7. J-E. Otterstedt and D. A. Brandreth, “Small Particles Technology”, Plenum Press, New York, p. 8, 1998.
8. A. M. Spasic and J-P. Hsu, “Finely Dispersed Particles: Micro-, Nano-, and Atto-Engineering”, Taylor & Francis, Roca Raton, pp. 329-340, 2006.
9. M. J. Rosen, “Surfactants and Interfacial Phenomena”, 3^{rd} Edition, Wiley-Intersciences, Hoboken, N.J., pp. 1-22, 2004.
10. T. C. Patton, “Paint Flow and Pigment Dispersion: A Rheological Approach to Coating and Ink Technology”, 2^{nd} Edition, John Wiley & Sons, New York, p. 270, 1979.

We claim:

1. An adsorbent composition for animal feed or food comprising:
(a) a clay component for adsorbing and deactivating a food toxin and inhibiting the development of bacteria or microorganisms in an animal feed, a binder precursor, optionally an additive, and a slurring medium;
(b) microspheres;

2. The adsorbent of claim 1 wherein the clay is selected from a group consisting of bentonite, montmorillonite, attapulgite, pillared clay, hydrotalcite, and or modified forms of bentonite and montmorillonite.

3. The adsorbent of claim 1 wherein the clay is at least 10 wt % of the composition, more preferably at least 11%, and even pore preferably 12%.

4. The adsorbent of claim 1 wherein the adsorbent composition is the form of microspheres.

5. The adsorbent of claim 1 wherein the microspheres are at least 10 microns in average particle size, more preferably at least 12 microns, and even more preferably at least 15 mcirons.

6. The adsorbent of claim 1 wherein the binder is selected from the group consisting of aluminum chlorohydrate, colloidal alumina sols, silica sols, colloidal aluminosilicates, colloidal metal oxides, and a combination thereof.

7. The adsorbent of claim 1 wherein the amount of binder in the adsorbent composition is at least 2 wt %, more preferably 2.5 wt %, and even more preferably 3 wt %.

8. The adsorbent of claim 1 wherein introduction of the binder has led to a significant reduction of slurry by at least 5%, more preferred by at least 10%, even more preferred by at least 15% all measured at 10 RPM.

9. The method and process of preparing an adsorbent composition comprising:
(a) combining a clay, a binder precursor, optionally an additive, and a slurring medium;
(b) forming a slurry containing a clay, a binder precursor, optionally an additive, and slurring medium;
(c) mixing and/or milling the slurry to achieve uniform mixing and homogenization of components and to achieve particle size reduction and desired slurry viscosity;
(d) shaping the slurry into microspherical particle via spray drying.

10. The method and process of claim 9, wherein the slurry contains at least 10 wt % solids, more preferably at least 12 wt %, and most preferably at least 15 wt %.

11. The method and process of claim 9, wherein mixing and milling is achieve using a high energy milling device using milling medium to facilitate particle size reduction.

12. The method and process of claim 9, wherein the mixing and milling has resulted in a significant increase in slurry viscosity, by at least 20% after one pass, and at least 25% after two passes and 35% after three passes.

13. The method and process of claim 9, wherein the milling medium is selected from a group consisting of high density, highly symmetric microspherical beads including alpha alumina, zirconia, stabilized zirconia, tungsten carbide, or other densified metal oxides in size from at least 0.1 mm, more preferably 0.2 mm, and even more preferably 0.25 mm.

14. The method and process of claim 9, wherein the milling throughput is at least 50 g/min, more preferably is at least 60 g/min, and even more preferably at least 80 g/min.

15. The method and process of claim 9, wherein the spray drying uses an atomization technique employing an wheel atomizer, or a two-fluid nozzle atomizer, or a single fluid pressurized atomizer to generate a spray dried particle products with an average particle size is at least 10 microns, more preferably 12 microns, and even more preferably 15 microns.

16. A method of mitigating, inhibiting the development of bacteria or microorganisms and adsorbing and deactivating a mycotoxin or aflatoxin in animal feed or food comprising: contacting the animal feed or food with the adsorbent composition wherein the adsorbent is in the form of microspheres consisting of a clay, an binder and optionally an additive.

17. A method of claim 16, wherein the amount of adsorbent added to the animal feed or food is at least 0.5 wt % of the total mass of the animal feed or food, more preferably at last 0.65 wt %, and even more preferably at least 0.75 wt %.

18. A method of claim 16, wherein the added adsorbent is in the form of microspheres that is at least 10 microns in size (d₅₀), more preferably at least 12 microns in size (d₅₀), and even more preferably at least 15 microns (d₅₀).

19. A method of claim 16, wherein the added adsorbent has a density at least 0.5 g/cc, more preferably at least 0.55 g/cc, and even more preferably at least 0.60 g/cc.
